(19) United States
(12) Patent Application Publication
(10) Pub. No.: US 2010/0034376 A1
(43) Pub. Date: Feb. 11, 2010

(54) INFORMATION MANAGING SYSTEM, ANONYMIZING METHOD AND STORAGE MEDIUM

(76) Inventors: Seiji Okuizumi, Tokyo (JP); Masao Satoh, Tokyo (JP); Akihisa Kenmochi, Tokyo (JP); Takeru Nakazato, Tokyo (JP); Kenichi Kamijo, Tokyo (JP)

Correspondence Address: Mr. Jackson Chen, 6535 N. STATE HWY 161, IRVING, TX, 75039, US

(21) Appl. No.: 12/517,538

(22) PCT Filed: Nov. 15, 2007
(86) PCT No.: PCT/JP2007/072178

§ 371 Date: Jun. 3, 2009

(30) Foreign Application Priority Data
Dec. 4, 2006 (JP) 2006-326739

(51) Int. Cl. H04L 9/00; H04L 9/32

(52) U.S. Cl. 380/44

(57) ABSTRACT

After anonymization of individual information such as clinical data, only the owner of a specimen data or the owner of a browsing right can identify data stored or related to it after the anonymization. Therefore, in an unlinkable anonymizing method, a uni-directional function such as a hash value calculation is applied to a combination data of related information such as an individual identifiable ID number or data, ID information and a key symbol in case of the anonymization, or a relational data such as a specimen number from only which an individual cannot be identified. A correspondence table of the anonymization number and the individual information is deleted. An estimation of an original individual or a specimen number from the anonymization number is prevented by use of uni-directional function. The access to the data after the anonymization is limited only to the owner who knows anonymization key data or the mandatory of the information.

### TECHNICAL FIELD

The present invention relates to an information managing system, and more particularly, to an information managing system using anonymized data. It should be noted that this patent application claims priority based on Japanese patent application No. 2006-326739, and the disclosure thereof is incorporated herein by reference.

### BACKGROUND ART

In general, in data anonymization, an anonymization number is used. Especially, in a medical institution from the viewpoint of individual information protection, data on a specimen should be anonymized. The anonymization number is obtained by performing encryption of or another operation for a unique ID (Identification) number for identifying an individual or an inspection specimen. An anonymizing method in which a correspondence table indicating correspondence between the anonymization number and an original ID number is discarded is referred to as an “unlinkable anonymizing method”, whereas an anonymizing method in which the correspondence table between the anonymization number and the original ID number is isolated in a safe place in consideration of later data processing is referred to as a “linkable anonymizing method”.

In the unlinkable anonymizing method, for example, the ID number made undecryptable by encryption is included in the anonymization number. Thus, by decrypting the encrypted ID number to compare the ID number with the original ID number, a determination whether post-anonymization data derives from the same individual or inspection specimen can be carried out even after the anonymization. In this case, a portion of the anonymization number which is obtained by encrypting an inspection specimen number or a patient number can be identified, and therefore even if the correspondence table between the anonymization number and the ID number has been discarded, the inspection specimen or patient may be identified if the encryption is decrypted.

Also, in a system in which it is assumed that patient prognosis data after anonymization processing is traced, and associated with post-anonymization specimen data and relational data, or post-anonymization data is erased according to a change in intention of an informant such as a patient, the linkable anonymizing method should be employed, instead of the unlinkable anonymizing method. In case of the linkable anonymizing method, a complicated system configuration is required to physically isolate “a system including pre-anonymization data”, and “a system not including the pre-anonymization data”, separate them by use of an advanced security technique, or record an access log or the like to protect or sense data leakage. Also, in some cases, very complicated check processing is required to identify data.

Further, regarding anonymization of data (specimen attribute data), only from which an individual cannot be identified, the anonymization of the specimen attribute data is achieved by extracting only data that cannot be used to identify the individual even if a plurality of data are simultaneously combined, or data of a combination of the plurality of data. In this case, data enough for research cannot be prepared because anonymity is reduced if a data extraction condition becomes ambiguous, and a condition required for a result analysis is lost in a data extracting system due to the anonymization of the specimen attribute data.

As described, in the anonymizing method, it is impossible that an owner of individual information, or mandatory assigned with a browsing right of the individual information such as a medical doctor or a researcher identify and browse/correct/delete post-anonymization data such as genome analysis data obtained from a patient specimen, which is obtained from the owner of the individual information.

Also, in case of anonymization by the unlinkable anonymizing method, when the intention of a patient on information provision based on informed consent is lost, it is impossible to perform an operation of re-associating post-anonymization data and relational data each other, and deleting the entire data on the patient. This is a large obstruction to an informant such as a patient.

Further, in case of anonymization by the unlinkable or linkable anonymizing method, it is difficult to re-associate the pre-anonymization data and data accumulated after the anonymization each other. The reason is in that, in case of the unlinkable anonymizing method, a data correspondence table re-associating the pre-anonymization data and the post-anonymization data each other has been discarded. Also, in case of the linkable anonymizing method, the reason is in that a system is characterized in that the pre-anonymization data and the post-anonymization data are physically separated from the viewpoint of individual information protection, which makes the reconnection operation significantly difficult. That is, progression of translational research is obstructed in which a state of a specimen such as patient prognosis data is traced to extract post-anonymization specimen data and relational data, which are subjected to data processing.

As a related technique, Japanese Patent Application Publication (JP-P2004-334433A) discloses an anonymization method, a user identifier management method, an anonymization apparatus, an anonymization program, and a program storage medium, in online service. In this related technique, a system providing an online service includes a member terminal of a member who is provided with the service, a client company server of a company to which the member belongs, and a counseling office server of a counseling office which provides the member with the service, which are all connected via a network. Also, an ID managing office server of an ID managing office anonymizes data on the member in the online service with an initial ID for anonymizing personal information in the company, and a login ID for anonymizing personal information about counseling.

Also, Japanese Patent Application Publication (JP-P2005-301978A) discloses a name storing control method. In this related technique, a process is performed in which an anonymous ID generated by a hash function using as a key a personal ID for identifying a specific person, and anonymity management data including one or more authorization conditions for use of the personal data are received. Then, a process is performed in which it is determined whether or not the received anonymous ID conflicts with another anonymous ID stored in a server, and a result of the determination is transmitted to a client. Subsequently, a process is performed in which the anonymous data for management is stored in a database when there is no confliction. After that, a process is performed in which the anonymous ID in the database, which is generated from the same personal ID as the received anonymous ID, is replaced by the received anonymous ID.

Also, Japanese Patent Application Publication (JP-a-Heisei 11-212461) discloses an electronic watermark system and electronic information delivery system. In this related technique, an encryption process and an electronic watermark burying process of data are distributedly performed by a plurality of means or a plurality of entities, and validity of at least one of the encryption process and the electronic watermark burying process performed by the plurality of means or the plurality of entities is verified by another means or entity that is different from the plurality of means or entities. In addition, the plurality of means or entities are at least three or more types of means or entities. For example, the plurality of entities include: a first entity having means adapted to perform a first encryption process of data; a second entity that has means adapted to perform the electronic watermark burying process, and manages and distributes the data from the first entity; and a third entity that has means adapted to perform a second encryption process, and uses data having an electronic watermark. In this case, the second entity may output a value into which data subjected to the second encryption process is converted by use of a uni-directional function. Also, the second entity may transmit to a fourth entity the value obtained by the conversion by use of the uni-directional function.

Also, Japanese Patent Application Publication (JP-P2004-180229A) discloses a program and a method of anonymity. In this related technique, two numerals are generated by re-arranging numerals of the respective digits constituting data to be anonymized. These numerals are made into binary digits, respectively; after that, the two numerals are generated by re-arranging numerals of 0/1 of the respective digits; and the re-arranged numerals are made into decimal digits, respectively. Then, a first 52-digit numeral is generated by arranging a numeral sequence constituting the numeral made into the decimal digit and a numeral sequence constituting another numeral made into the decimal digit, and making it into 52 digits, and an optional numeral sequence among the remaining numeral sequence constituting another numeral made into the decimal digit is made into 52 digits. The anonymized data is finally generated by arranging the numerals made into the 52 digits and the remaining numeral sequences constituting the numerals made into the decimal digits.

Further, Japanese patent No. 3357039 discloses an anonymization clinical research support method and a system therefor. In this related technique, a patient information managing system manages patient data such as personal information about a patient or diagnostic data, and data about a specimen taken from the patient. The anonymizing system generates an anonymization specimen number in which a specimen number given to the specimen is made to be anonymized, and stores a linkable anonymization code table in which the specimen number is corresponded to the anonymized specimen number. The specimen and the patient information to be anonymized are provided for a research side. An experimental specimen managing system on the research side manages the patient information and the specimen to be anonymized, and amplifies an objective arrangement (base arrangement) by PCR (Polymerase Chain Reaction) or a cDNA (complementary DNA) library necessary for the genetic analysis, and in a genome basic data management system, cDNA arrangement decision, manifestation analysis, SNP (Single Nucleotide Polymorphism) typing, and arrangement decision in a target area are executed.

### DISCLOSURE OF INVENTION

An object of the present invention is to provide an information managing system, an anonymizing method, and a storage medium, in which after anonymization processing of specimen data (individual information) such as clinical data, an owner of the specimen data and an owner of a browsing right can identify an individual based on data related to data subjected to an anonymization process.

The information managing system of the present invention includes an individual ID storage section configured to store an individual ID number allowing an individual to be identified; an anonymization number generating section configured to generate an anonymization number anonymized by use of a uni-directional function on the basis of the individual ID number; and a correspondence table discarding section configured to discard a correspondence table of the individual ID number and the anonymization number.

The anonymizing method of the present invention includes (a) acquiring an individual ID number allowing an individual to be identified; (b) generating an anonymization number anonymized by use of a uni-directional function on the basis of the individual ID number; and (c) discarding a correspondence table of the individual ID number and the anonymization number.

An anonymizing program of the present invention instructs a processor mounted on a computer and the like to perform the anonymizing method. In addition, the anonymizing program is stored in a storage unit or storage medium.

In the unlinkable anonymizing method, a combination data in which identification data for identifying an individual, such as the individual ID number, and relational data such as an anonymization key symbol and the specimen number are combined is used to generate the anonymization number by use of a uni-directional function for hash value calculation or the like. Also, because of difficulty in calculation of an inverse function of the uni-directional function, flexible data analysis becomes possible with security being established.

### BRIEF DESCRIPTION OF DRAWINGS

FIG. 1 is a diagram illustrating a basic configuration of an unlinkable anonymizing system;

FIG. 2A is a diagram illustrating a first exemplary embodiment of the present invention;

FIG. 2B is a diagram illustrating a reference case for comparing with the first exemplary embodiment of the present invention;

FIG. 3 is a diagram illustrating a second exemplary embodiment of the present invention;

FIG. 4 is a diagram illustrating a third exemplary embodiment of the present invention;

FIG. 5 is a diagram illustrating a fourth exemplary embodiment of the present invention;

FIG. 6 is a diagram illustrating a fifth exemplary embodiment of the present invention;

FIG. 7 is a diagram illustrating a sixth exemplary embodiment of the present invention;

FIG. 8A is a diagram illustrating an example of encryption after anonymization in a seventh exemplary embodiment of the present invention; and

FIG. 8B is a diagram illustrating an example of anonymization after encryption in the seventh exemplary embodiment of the present invention.

### BEST MODE FOR CARRYING OUT THE INVENTION

Hereinafter, a configuration of an unlinkable anonymizing system according to exemplary embodiments of the present invention will be described with reference to the attached drawings.

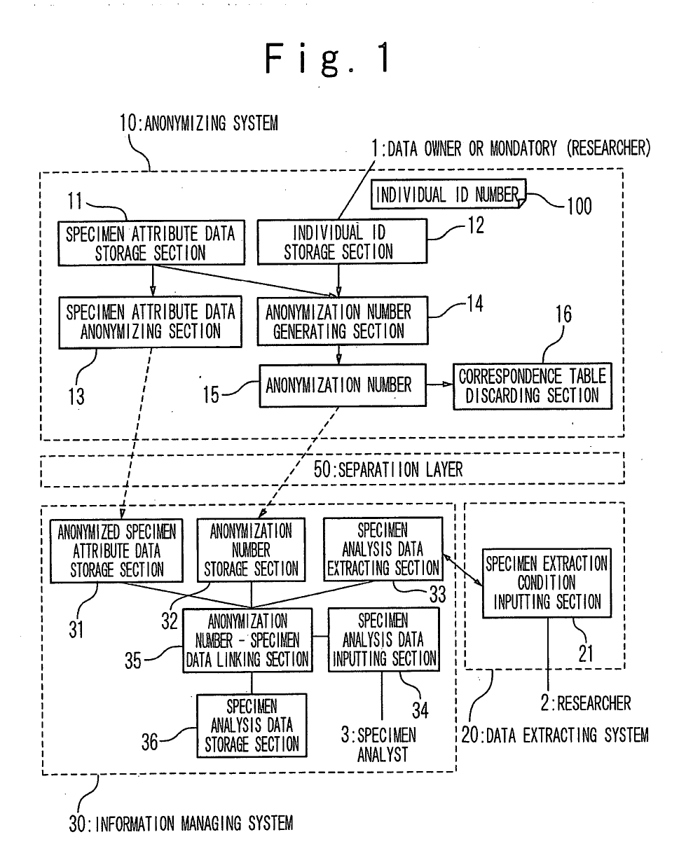

Referring to FIG. 1, the unlinkable anonymizing system includes an anonymizing system 10, a data extracting system 20, and an information managing system 30. The anonymizing system 10 and the information managing system 30 can communicate each other. Also, the data extracting system 20 and the information managing system 30 can communicate each other. The respective systems may be connected through a network such as a telecommunication line, a public telephone network, and a dedicated line. Between the anonymizing system 10 and the information managing system 30, a separation layer 50 is present.

The anonymizing system 10 includes a specimen attribute data storage section 11, an individual ID storage section 12, a specimen attribute data anonymizing section 13, an anonymization number generating section 14, an anonymization number 15, and a correspondence table discarding section 16.

The specimen attribute data storage section 11 stores data (specimen attribute data) only with which an individual cannot be identified, and provides the stored specimen attribute data to the specimen attribute data anonymizing section 13 and the anonymization number generating section 14. The individual ID storage section 12 obtains and stores an individual ID number 100 provided by an information owner or a mandatory (researcher) 1, and provides the stored individual ID number 100 to the anonymization number generating section 14. The individual ID number 100 is an identification data allowing an individual to be identified, such as an ID number. The specimen attribute data anonymizing section 13 anonymizes the specimen attribute data obtained from the specimen attribute data storage section 11 to generate an anonymized specimen attribute data, and provides the anonymized specimen attribute data to an information managing system 30. The anonymization number generating section 14 generates an anonymized anonymization number 15 by combining the specimen attribute data obtained from the specimen attribute data storage section 11 and the individual ID number 100 obtained from the individual ID storage section 12. That is, the anonymization number 15 includes the anonymized individual ID number 100, and the anonymized specimen attribute data. The anonymized specimen attribute data corresponds to the anonymized specimen attribute data generated by the specimen attribute data anonymizing section 13. At this time, the anonymization number generating section 14 generates a correspondence table relating the individual ID number 100 and the anonymization number 15 to each other. Accordingly, if the correspondence table relating the individual ID number 100 and the anonymization number 15 to each other, or the anonymized specimen attribute data is referred to, the individual ID number 100 or the specimen attribute data can be identified from the anonymization number 15. Also, the anonymization number 15 is provided to the information managing system 30. The correspondence table discarding section 16 discards the correspondence table relating the individual ID number 100 and the anonymization number 15 to each other, in accordance with an instruction from the information owner or the mandatory (researcher) 1, or satisfaction of a predetermined condition.

The data extracting system 20 includes a specimen extraction condition inputting section 21. The specimen extraction condition inputting section 21 provides a specimen extraction condition inputted by a researcher 2 to the information managing system 30, and provides specimen analysis data provided from the information managing system 30 the researcher 2 in accordance with the specimen extraction condition.

The information managing system 30 includes an anonymized specimen attribute data storage section 31, an anonymization number storage section 32, a specimen analysis data extracting section 33, a specimen analysis data inputting section 34, an data linking section 35, and a specimen analysis data storage section 36.

The anonymized specimen attribute data storage section 31 stores the anonymized specimen attribute data obtained from the specimen attribute data anonymizing section 13. The anonymization number storage section 32 stores the anonymization number 15 obtained from an anonymizing system 10. The specimen analysis data extracting section 33 extracts the specimen analysis data from the data linking section 35 on the basis of a specimen extraction condition obtained from the specimen extraction condition inputting section 21, and provides the extracted specimen analysis data to the specimen extraction condition inputting section 21. That is, the specimen analysis data extracting section 33 extracts the specimen analysis data from the data linking section 35 on the basis of the specimen extraction condition inputted by the researcher 2, and provides the extracted specimen analysis data to the researcher 2 through the specimen extraction condition inputting section 21. The specimen analysis data inputting section 34 provides the specimen analysis data inputted by a specimen analyst 3 to the data linking section 35. The data linking section 35 obtains the anonymized specimen attribute data stored in the anonymized specimen attribute data storage section 31 and the anonymization number 15 stored in the anonymization number storage section 32, and links (associates) the obtained anonymization number 15 and the anonymized specimen attribute data to (with) the specimen analysis data received from the specimen analysis data inputting section 34. It should be noted that the data linking section 35 may link (associate) the anonymization number 15 to (with) the anonymized specimen attribute data by comparing the anonymized specimen attribute data included in the anonymization number 15 with the anonymized specimen attribute data. Also, the data linking section 35 may obtain previously stored specimen analysis data from the specimen analysis data storage section 36, when it cannot obtain the specimen analysis data from the specimen analysis data inputting section 34. the data linking section 35 provides the linked specimen analysis data to the specimen analysis data extracting section 33 in response to a request from the specimen analysis data extracting section 33. The specimen analysis data storage section 36 stores the specimen analysis data that is predetermined or has been inputted to the specimen analysis data inputting section 34 in past. At this time, the specimen analysis data storage section 36 may be adapted to obtain the linked specimen analysis data from the data linking section 35 to store it, and provide the linked specimen analysis data to the specimen analysis data extracting section 33 in response to a request from the specimen analysis data extracting section 33.

The separation layer 50 is often used to separate between s high-reliability network and a low-reliability network. Here, the separation layer 50 is used to physically isolate a system including pre-anonymization data from a system not including pre-anonymization data. Also, by using a plurality of layers as the separation layer 50, one or more hosts or networks can be isolated, divided, or separated from other hosts or networks by each of the plurality of layers.

A first exemplary embodiment of the present invention will be described below. In the first exemplary embodiment of the present invention, identification data allowing an individual to be identified, such as an ID number, is used in the unlinkable anonymization to generate an anonymization number by use of a uni-directional function. As the uni-directional function to be used, an MD5 (Message Digest 5), SHA (Secure Hash Algorithm), or RSA (Rivest Shamir Adleman) function can be used, but the uni-directional function is not limited to any of such examples in practice. As a specific example, a hash value is generated by converting a patient ID for identifying an individual by use of the SHA hash function, and employed as the anonymization number. Reverse calculation of the patient ID from the generated anonymization number is difficult, and if a correspondence table between the patient ID and the anonymization number is deleted on the basis of the unlinkable anonymization, it becomes actually impossible to decrypt the anonymization number into the corresponding patient ID.

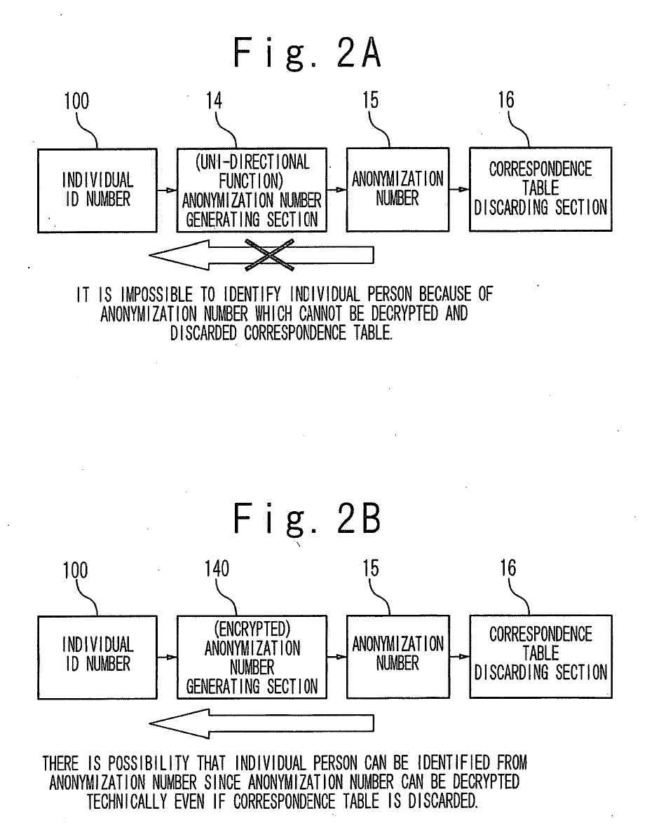

Referring to FIG. 2A, the present exemplary embodiment will be described. Here, the individual ID number 100, the anonymization number generating section 14, the anonymization number 15, and the correspondence table discarding section 16 are used to give the description.

The individual ID number 100 is identification data allowing an individual to be identified, such as an ID number. Here, the individual ID number 100 is stored in the individual ID storage section 12 illustrated in FIG. 1. The anonymization number generating section 14 applies the “uni-directional function” to the individual ID number 100 to generate the anonymization number. The anonymization number 15 is generated by the anonymization number generating section 14. After the generation of the anonymization number 15, the correspondence table discarding section 16 discards a correspondence table between the anonymization number 15 and the individual ID number 100.

In the present exemplary embodiment, the undecryptable anonymization number applied with the uni-directional function is used, and the correspondence table between the anonymization number and the individual ID number has been discarded. Thus, the individual cannot be identified. Therefore, a data flow is uni-directional from the individual ID number 100 to the correspondence table discarding section 16.

In order to describe features of the present exemplary embodiment, a reference case where the uni-directional function is not applied will be described with reference to FIG. 2B. Here, the individual ID number, an anonymization number generating section 140, the anonymization number 15, and the correspondence table discarding section 16 are used to give the description. A difference between the present exemplary embodiment of FIG. 2A and the reference case corresponds to a difference between the anonymization number generating section 14 and the anonymization number generating section 140. The remaining portion of the configuration is the same as that in FIG. 2A. The anonymization number generating section 140 generates the anonymization number through “encryption” on the basis of the individual ID number 100.

Unlike the present exemplary embodiment, in the above-described reference case, the anonymization number can be technically decrypted, and therefore even if the correspondence table has been discarded, there is a possibility that an individual is identified from the anonymization number.

A second exemplary embodiment of the present invention will be described below. In the second exemplary embodiment of the present invention, in the information managing system generating an anonymization number by use of a uni-directional function, in order to avoid a cryptanalytic attack obtaining an arbitrary plain text in a round robin fashion, a combination of identification data allowing an individual to be identified, such as an ID number, and relation data only with which the individual cannot be identified, such as a specimen number, is used to generate the anonymization number by use of the uni-directional function. As a specific example, in case of generating the anonymization number by use of the uni-directional function, a patient ID for identifying an individual, and a birth date and gender of the corresponding patient are linked to each other, and then the anonymization number is calculated by use of the uni-directional function.

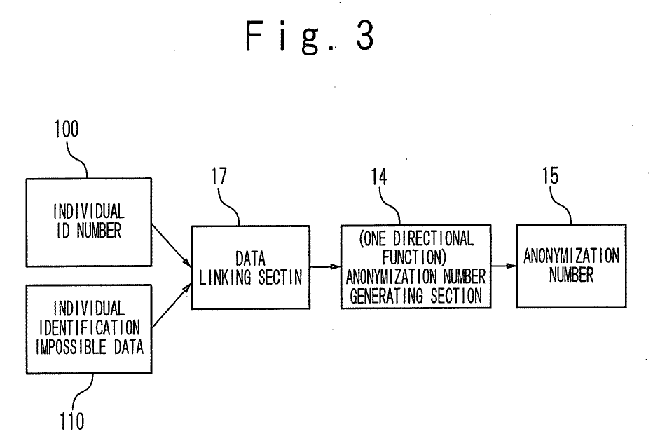

Referring to FIG. 3, the present exemplary embodiment will be described. Here, the individual ID number 100, individual identification impossible data 110, the data linking section 17, the anonymization number generating section 14, and the anonymization number 15 are used to give the description.

The individual ID number 100 is identification data allowing an individual to be identified, such as an ID number. Here, it is obtained from the individual ID storage section 12 illustrated in FIG. 1. The individual identification impossible data 110 is a data only with which the individual cannot be identified. For example, as the individual identification impossible data 110, the specimen attribute data stored in the specimen attribute data storage section 11 illustrated in FIG. 1 is presumed. The data linking section 17 links the individual ID number 100 and the individual identification impossible data 110 to provide the linked data to the anonymization number generating section 14. The anonymization number generating section 14 uses the data obtained from the data linking section 17 to generate the anonymization number by use of the uni-directional function. The anonymization number 15 is generated by the anonymization number generating section 14.

A third exemplary embodiment of the present invention will be described below. In the third exemplary embodiment of the present invention, an individual cannot be identified from the anonymization number. By using identification data that allows the individual to be identified, such as an ID number, the anonymization number is generated by use of the uni-directional function, in order to allow only an information owner or a mandatory (researcher) to search/browse/correct/delete post-anonymization data.

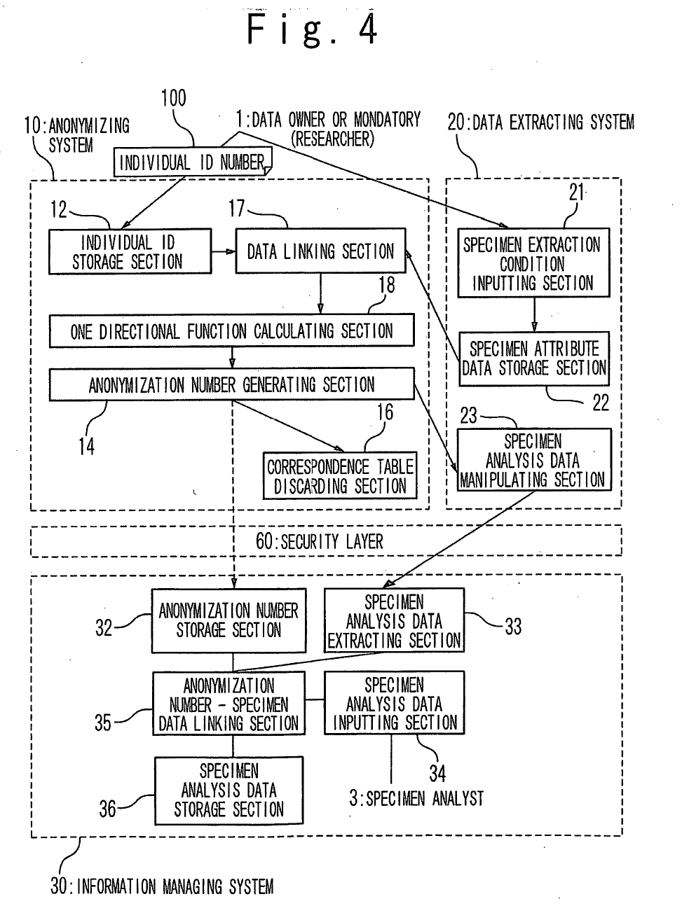

Referring to FIG. 4, an unlinkable anonymizing system in the present exemplary embodiment includes the anonymizing system 10, the data extracting system 20, and the information managing system 30. The anonymizing system 10 and the information managing system 30 can communicate each other. Also, the data extracting system 20 and the information managing system 30 can communicate each other. The respective systems may be connected through a network such as a telecommunication line, a public telephone network, or a dedicated line. Between the anonymizing system 10 and the information managing system 30, and between the data extracting system 20 and the information managing system 30, a security layer 60 is present. Accordingly, upon communication between the anonymizing system 10 or the data extracting system 20, and the information managing system 30, authentication is performed.

The anonymizing system 10 includes the individual ID storage section 12, the anonymization number generating section 14, the correspondence table discarding section 16, the data linking section 17, and a uni-directional function calculating section 18.

The individual ID storage section 12 obtains the individual ID number 100 from the information owner or mandatory (researcher) 1 to store it, and provides the stored data to the data linking section 17. The data linking section 17 provides combination data in which specimen attribute data obtained from an data extracting system 20 and the individual ID number 100 obtained from the individual ID storage section 12 are connected to each other, to the uni-directional function calculating section 18. The uni-directional function calculating section 18 calculates a uni-directional function used for anonymization, and provides the uni-directional function and the combination data obtained from the data linking section 17 to the anonymization number generating section 14. The anonymization number generating section 14 provides the anonymization number, which is obtained by anonymizing the combination data by use of the uni-directional function, to the correspondence table discarding section 16, the data extracting system 20, and the information managing system 30. The correspondence table discarding section 16 discards the correspondence table relating the individual ID number 100 and the anonymization number to each other, in accordance with a request from the information owner or the mandatory (researcher) 1, or satisfaction of a predetermined condition.

The data extracting system 20 includes the specimen extraction condition inputting section 21, a specimen attribute data storage section 22, and a specimen analysis data manipulating section 23.

The specimen extraction condition inputting section 21 provides a specimen extraction condition inputted by the information owner or mandatory (researcher) 1 to the specimen attribute data storage section 22. The specimen attribute data storage section 22 provides the specimen attribute data to the anonymizing system 10 on the basis of the specimen extraction condition obtained from the specimen extraction condition inputting section 21. The specimen analysis data manipulating section 23 is used to operate or manipulate specimen analysis data corresponding to the anonymization number obtained from the anonymization number generating section 14, and provides the manipulated specimen analysis data to the information managing system 30. It should be noted that the manipulation includes at least one of search, correction, and deletion.

The information managing system 30 includes the anonymization number storage section 32, the specimen analysis data extracting section 33, the specimen analysis data inputting section 34, the data linking section 35, and the specimen analysis data storage section 36.

The anonymization number storage section 32 provides the anonymization number obtained from the anonymization number generating section 14 to the data linking section 35. The specimen analysis data extracting section 33 provides the specimen extraction condition and specimen analysis data obtained from the specimen analysis data manipulating section 23 to the data linking section 35. The specimen analysis data inputting section 34 provides the specimen analysis data inputted by a specimen analyst 3 to the data linking section 35. The data linking section 35 links the anonymization number and the specimen attribute data on the basis of the specimen extraction condition and the specimen analysis data. Alternatively, when the data linking section 35 cannot obtain the specimen analysis data from the specimen analysis data inputting section 34, it obtains the specimen analysis data stored in the specimen analysis data storage section 36. The specimen analysis data storage section 36 stores the specimen analysis data that is predetermined, or has been inputted to the specimen analysis data inputting section 34 in past.

In the above system, the specimen analyst 20 can know the specimen analysis data, but cannot identify the individual corresponding to a target specimen because the correspondence table between the individual ID number and the anonymization number has been discarded. On the other hand, even after the information anonymization, the information owner or the mandatory can trace the data related to the post-anonymization number by using the anonymizing system again, and perform manipulation of the post-anonymization data, such as deletion. That is, even after the anonymization, the information owner or the mandatory can associate the anonymization number and the corresponding post-anonymization data each other by using the data related to the anonymization number as a key. Accordingly, it is not necessary to decrypt the anonymized anonymization number, and therefore uni-directionalness of data can be kept.

The specimen attribute data is not stored in the specimen information managing system, so that data allowing the individual to be identified by combining a plurality of data can be completely isolated from the specimen analyst 20, and therefore anonymity can be ensured.

A fourth exemplary embodiment of the present invention will be described below. In the fourth exemplary embodiment of the present invention, the information managing system will be described in which only the information owner or the mandatory (researcher) can browse/correct/delete post-anonymization data, and which includes: a component for generating an anonymization key upon generation of an anonymization number by use of the uni-directional function; a component for linking identification data allowing an individual to be identified, such as an ID number; and a component for decrypting the anonymization number generated from the anonymization key into an individual ID number by use of anonymization key data. Upon calculation of the anonymization number, data or password that only the information owner or the mandatory (researcher) can know is used while a cryptanalytic attack obtaining an arbitrary plain text in a round robin fashion is avoided by combining with the anonymization key, and thereby the system can be constructed in which the information owner or mandatory (researcher) is identified and can browse/correct/delete the post-anonymization data.

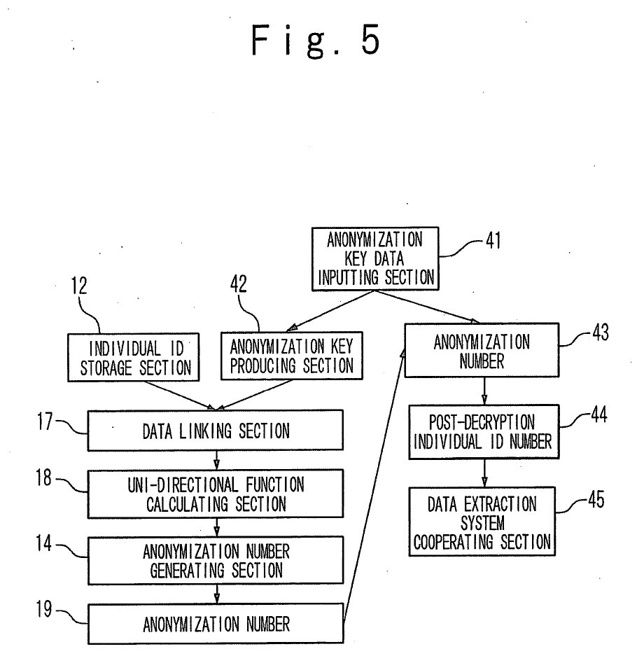

Referring to FIG. 5, the present exemplary embodiment will be described. Here, the individual ID storage section 12, the anonymization number generating section 14, the data linking section 17, the uni-directional function calculating section 18, an anonymization number 19, an anonymization key data inputting section 41, an anonymization key producing section 42, an anonymization number decrypting section 43, a post-decryption individual ID number 44, and an data extracting system cooperating section 45 are used to give the description. In addition, it is assumed that the individual ID storage section 12, the anonymization number generating section 14, the data linking section 17, the uni-directional function calculating section 18, the anonymization number 19, the anonymization key data inputting section 41, the anonymization key producing section 42, the anonymization number decrypting section 43, the post-decryption individual ID number 44, and the data extracting system cooperating section 45 are provided in the anonymizing system 10 illustrated in FIG. 1 or 4, or a device linked with the anonymizing system 10.

The individual ID storage section 12 stores the individual ID number 100, and provides it to the data linking section 17. The data linking section 17 provides combination data obtained by clinking the individual ID number 100 obtained from the individual ID storage section 12 and the anonymization key obtained from the anonymization key producing section 42, to the uni-directional function calculating section 18. The uni-directional function calculating section 18 calculates the uni-directional function used for the anonymization, and provides the uni-directional function and the combination data obtained from the data linking section 17 to the anonymization number generating section 14. The anonymization number generating section 14 provides the anonymization number obtained by anonymizing the combination data with the anonymization key, to the anonymization number decrypting section 43. The anonymization number 19 is the anonymization number that is generated by the anonymization number generating section 14, anonymized by use of the uni-directional function, and does not allow a corresponding individual or attribute data to be identified.

The anonymization key data inputting section 41 is used to input data required to generate the anonymization key. The anonymization key producing section 42 produces the anonymization key on the basis of the data obtained from the anonymization key data inputting section 41, and provides it to the data linking section 17. It should be noted that the anonymization key producing section 42 may be present inside the anonymizing system 10. The anonymization number decrypting section 43 obtains the anonymization number 19, and decrypts the anonymization number 19 by use of the anonymization key generated on the basis of the data obtained from the anonymization key data inputting section 41. The post-decryption individual ID number 44 is generated by the anonymization number decrypting section 43. The data extracting system cooperating section 45 obtains the post-decryption individual ID number 44, and provides it to the data extracting system 20. For example, the data extracting system cooperating section 45 provides it to the specimen analysis data manipulating section 23 illustrated in FIG. 4. Alternatively, the data extracting system cooperating section 45 may be adapted to provide the post-decryption individual ID number 44 along with data obtained from the data extracting system 20 to the information managing system 30.

It should be noted that, the anonymization key data inputting section 41, the anonymization key producing section 42, the anonymization number decrypting section 43, the post-decryption individual ID number 44, and the data extracting system cooperating section 45 may be independent devices, and may be included in the data extracting system 20 or the information managing system 30.

A fifth exemplary embodiment of the present invention will be described below. In the fifth exemplary embodiment of the present invention, an information managing system will be described in which only an information owner or a mandatory (researcher) can browse/correct/delete post-anonymization data, and which includes: a component for discarding data on an anonymization key. By discarding the data on the anonymization key, only the information owner or the mandatory (researcher) who can know the data on the anonymization key can associate the post-anonymization data with an original individual ID number to refer to the associated data without leaking the anonymization key.

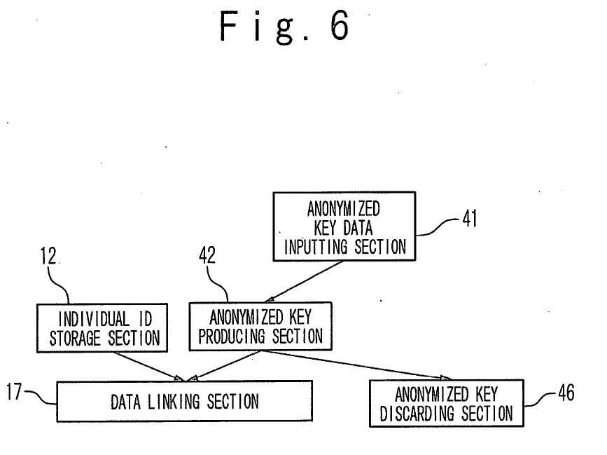

Referring to FIG. 6, the present exemplary embodiment will be described. Here, the individual ID storage section 12, the data linking section 17, the anonymization key data inputting section 41, the anonymization key producing section 42, and an anonymization key discarding section 46 are used to give the description. In addition, it is assumed that the individual ID storage section 12, the data linking section 17, the anonymization key data inputting section 41, the anonymization key producing section 42, and the anonymization key discarding section 46 are provided in the anonymizing system 10 illustrated in FIG. 1 or 4, or a device linked with the anonymizing system 10.

The individual ID storage section 12 stores the individual ID number 100, and provides it to the data linking section 17. The data linking section 17 links the individual ID number 100 obtained from the individual ID storage section 12 and the anonymization key obtained from the anonymization key producing section 42.

The anonymization key data inputting section 41 is used to input data required to generate the anonymization key. The anonymization key producing section 42 generates the anonymization key on the basis of the data obtained from the anonymization key data inputting section 41, and provides it to the data linking section 17. The anonymization key discarding section 46 discards the anonymization key generated by the anonymization key producing section 42 in response to an instruction from the information owner or the mandatory (researcher) 1, or a predetermined condition. It should be noted that the anonymization key producing section 42 and the anonymization key discarding section 46 may be present inside the anonymizing system 10.

A sixth exemplary embodiment of the present invention will be described below. In the sixth exemplary embodiment of the present invention, an anonymizing method will be described which includes the steps of: verifying uniqueness of an anonymization number generated by use of a uni-directional function among a group of anonymization numbers registered in a system; notifying a result of the verification to an anonymization number producing section; and upon the verification result indicating that it is not unique, promoting re-selection of anonymization key data or data (specimen attribute data) only with which an individual cannot be identified, with respect to the anonymization number.

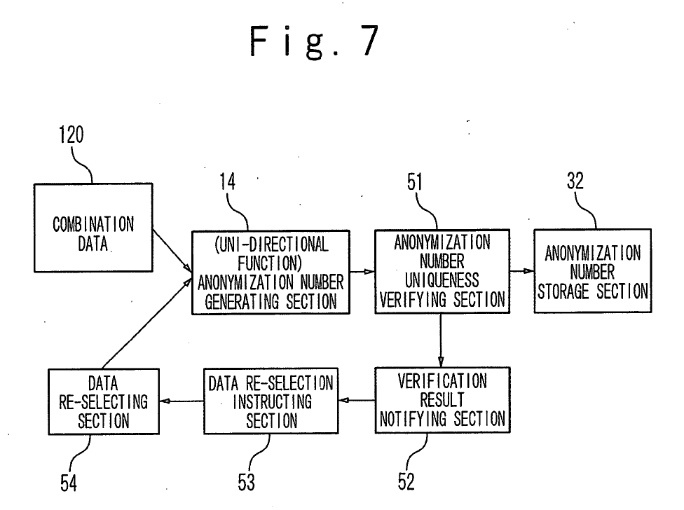

Referring to FIG. 7, the present exemplary embodiment will be described. Here, the combination data 120, the anonymization number generating section 14, an anonymization number uniqueness verifying section 51, the anonymization number storage section 32, an verification result notifying section 52, an data reselection instructing section 53, and an data re-selecting section 54 are used to give the description. In addition, it is assumed that the anonymization number generating section 14, the anonymization number uniqueness verifying section 51, the verification result notifying section 52, the data reselection instructing section 53, and the data re-selecting section 54 are provided in the anonymizing system 10 illustrated in FIG. 1 or 4, or a device linked with the anonymizing system 10. Also, it is assumed that the anonymization number storage section 32 is provided in the information managing system 30 illustrated in FIG. 1 or 4.

The combination data 120 is data in which identification data such as an individual ID number, an anonymization key symbol, and relational data are combined. The combination data 120 may be one generated by the data linking section 17 illustrated in FIG. 5 or 6. The anonymization number generating section 14 uses the combination data 120 to generate the anonymization number by use of the uni-directional function. The anonymization number generating section 14 may include the uni-directional function calculating section 18 illustrated in FIG. 4 or 5. The anonymization number uniqueness verifying section 51 verifies the uniqueness of the anonymization number generated by the anonymization number generating section 14. The anonymization number storage section 32 stores the anonymization number obtained from the anonymization number uniqueness verifying section 51. The verification result notifying section 52 obtains a result of the verification of the uniqueness from the anonymization number uniqueness verifying section 51. Upon the verification result of the uniqueness indicating that it is not unique, the data reselection instructing section 53 promotes the reselection of the anonymization key data or data only with which the individual cannot be identified, with respect to the anonymization number, and receives an instruction of the reselection. The data re-selecting section 54 reselects target data in response to the instruction of the reselection from the data reselection instructing section 53.

A seventh exemplary embodiment of the present invention will be described below. In the seventh exemplary embodiment of the present invention, a method will be described which generates a first or second anonymization number by use of a uni-directional function based on combination data in which identification data for identifying an individual, such as an individual ID number, an anonymization key symbol, and relational data are combined.

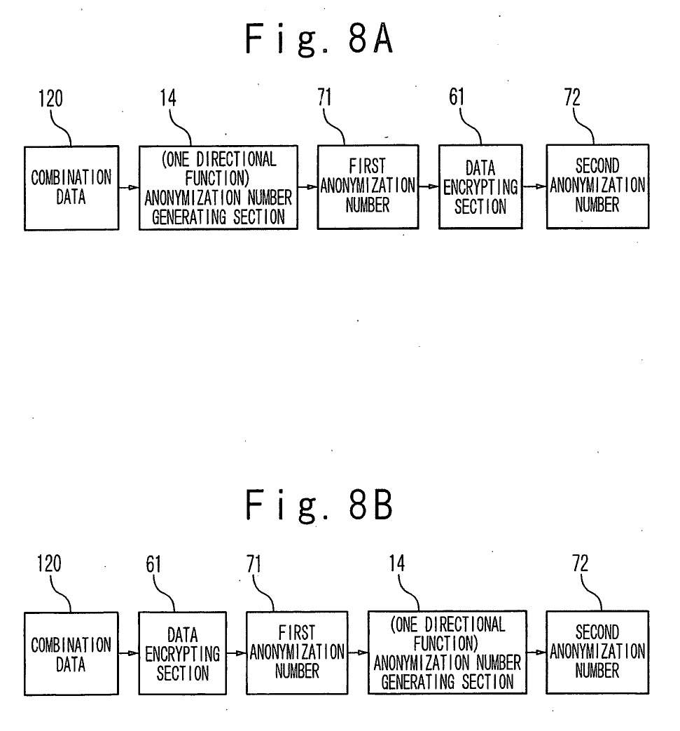

Referring to FIGS. 8A and 8B, the present exemplary embodiment will be described. In FIG. 8A, the individual ID number and the combination data including the anonymization key symbol are anonymized, and then encrypted. Also, in FIG. 8B, the individual ID number and the combination data including the anonymization key symbol are encrypted, and then anonymized.

Here, the combination data 120, the anonymization number generating section 14, a data encrypting section 61, a first anonymization number 71, and a second anonymization number 72 are used to give the description. In addition, it is assumed that the anonymization number generating section 14 and the data encrypting section 61 are provided in the anonymizing system 10 illustrated in FIG. 1 or 4, or a device linked with the anonymizing system 10.

In an example illustrated in FIG. 8A, the combination data 120 is data in which the identification data such as the individual ID number, the anonymization key symbol, and relational data are combined. The combination data 120 may be one generated by the data linking section 17 illustrated in FIG. 5 or 6. The anonymization number generating section 14 uses the combination data 120 to generate an anonymization number by use of the uni-directional function. The anonymization number generating section 14 may include the uni-directional function calculating section 18 illustrated in FIG. 4 or 5. The first anonymization number 71 is generated by the anonymization number generating section 14. That is, the first anonymization number 71 illustrated in FIG. 8A is obtained by anonymizing the combination data 120 by use of the uni-directional function. The data encrypting section 61 encrypts the first anonymization number 71. The second anonymization number 72 is generated by the data encrypting section 61. That is, the second anonymization number 72 illustrated in FIG. 8A is obtained by encrypting the first anonymization number 71. Accordingly, the second anonymization number 72 illustrated in FIG. 8A is obtained by anonymizing the combination data 120 by use of the uni-directional function and by further encrypting it.

In an example illustrated in FIG. 8B, the combination data 120 is data in which the identification data such as the individual ID number, the anonymization key symbol, and the relational data are combined. The combination data 120 may be one generated by the data linking section 17 illustrated in FIG. 5 or 6. The data encrypting section 61 encrypts the combination data 120. The first anonymization number 71 is generated by the data encrypting section 61. That is, the first anonymization number 71 illustrated in FIG. 8B is obtained by encrypting the combination data 120. The anonymization number generating section 14 uses the first anonymization number 71 to generate an anonymization number by use of the uni-directional function. The anonymization number generating section 14 may include the uni-directional function calculating section 18 illustrated in FIG. 4 or 5. The second anonymization number 72 is generated by the anonymization number generating section 14. That is, the second anonymization number 72 illustrated in FIG. 8B is obtained by anonymizing the first anonymization number 71 by use of the uni-directional function. Accordingly, the second anonymization number 72 illustrated in FIG. 8B is obtained by further anonymizing the encrypted combination data 120 by use of the uni-directional function.

In the present exemplary embodiment, the second anonymization number 72 corresponds to the anonymization number generated by the anonymization number generating section 14 illustrated in FIG. 4 or 5.

It should be noted that the respective exemplary embodiments of the present invention may be combined for use. For example, the present invention may be adapted such that, upon start of processing, one can select which of the exemplary embodiments to perform the processing. Also, when a specific one of the exemplary embodiments cannot be performed due to a lack of input data, the processing may be performed on the basis of the other performable one.

As described above, in the present invention, in the unlinkable anonymizing method, identification data allowing an individual to be identified, such as an individual ID number, or combination data in which the identification data such as the individual ID number, and the key symbol for anonymization or relational data only with which the individual cannot be identified, such as a specimen number, are combined is used to generate an anonymization number by use of a uni-directional function for hash value calculation or the like.

Also, by using anonymization key data to perform anonymization such that the method for generating the anonymization number cannot be analogized upon the generation of the anonymization number, and not storing the anonymization key data in the same system, the system in which anonymity of data is kept even if the anonymizing method is disclosed can be constructed.

There can be constructed a system in which a correspondence table between the anonymization number and the individual data has been deleted because of the unlinkable anonymization, so that an original individual or a specimen number cannot be analogized from the anonymization number in practice because of the use of the uni-directional function, and access to post-anonymization data can be limited only to an information owner or a mandatory (e.g., medical doctor) who knows the anonymization key data.

1-24. (canceled)

25. An information management system, in which an individual data and an anonymization number are managed to have a correspondence relation, and a correspondence table of an individual ID number for identifying an individual and the anonymization number is not retained, comprising:
an anonymization key data inputting section configured to receive the individual ID number, and an input of an anonymization key data for calculating the anonymization number when the anonymization number is generated or recovered in order to refer to the individual data having the correspondence relation to the anonymization number;
a data linking section configured to link the individual ID number and the anonymization key data based on the anonymization key data;
an anonymization number generating section configured to generate the anonymization number by performing calculation to the linked data by said data linking means by use of a uni-directional function; and
a correspondence table discarding section configured to discard the correspondence table of the individual ID number and the anonymization number after generation of the anonymization number.

26. The information management system according to claim 25, further comprising:
anonymization key discarding means for discarding the anonymization key data.

27. The information management system according to claim 25, further comprising:
a specimen attribute data storage means for storing a specimen attribute data, from only which the individual cannot be identified; and
said data linking means links the individual ID number and the specimen attribute data to provide to said anonymization number generating means.

28. The information management system according to claim 25, further comprising:
an anonymization number uniqueness verifying section configured to verify a uniqueness of the anonymization number generated by said anonymization number generating section;
a verification result notifying section configured to acquire a verification result from said anonymization number uniqueness verifying section; and
a data re-selecting section configured to perform re-input of the anonymization key data corresponding to the anonymization number or re-selection of the specimen attribute data from only which the individual cannot be identified, when the verification result indicates that the anonymization number is not unique.

29. The information management system according to claim 25, further comprising:
a data encrypting section configured to encrypt means for encrypting a first anonymization number generated by said anonymization number generating section into a second anonymization number based on a combination data obtained by linking the individual ID number, and at least one of the anonymization key data and the specimen attribute data.

30. The information management system according to claim 25, further comprising:
a data encrypting section configured to encrypt a combination data obtained by linking the individual ID number, and at least one of the anonymization key data and the specimen attribute data to generate a first anonymization number,
wherein said anonymization number generating section generates a second anonymization number by anonymizing the first anonymization number by use of the uni-directional function.

31. An anonymizing method in which an individual data and an anonymization number are managed to have a correspondence relation, and a correspondence table of an individual ID number for identifying an individual and the anonymization number is not retained, comprising:
acquiring an individual ID number used to generate an anonymization key;
acquiring an anonymization key data used to generate the anonymization key;
generating an anonymization number anonymized by use of an uni-directional function by linking the individual ID number and the anonymization key data; and
discarding a correspondence table of the individual ID number and the anonymization number after the generation of the anonymization number.

32. The anonymizing method according to claim 31, further comprising:
discarding the anonymization key.

33. The anonymizing method according to claim 31, wherein said generating an anonymization number comprises:
acquiring specimen attribute data from only which the individual cannot be identified; and
generating the anonymization number obtained by anonymizing a combination data which is obtained by linking the individual ID number, the anonymization key data and the specimen attribute data, by use of the uni-directional function.

34. The anonymizing method according to claim 31, further comprising:
verifying an uniqueness of the anonymization number; and
performing a re-input of the anonymization key data corresponding to the anonymization number or reselection of the specimen attribute data from only which an individual cannot be identified, when the verification result indicates that the anonymization number is not unique.

35. The anonymizing method according to claim 31, wherein said generating an anonymization number comprises:
generating a first anonymization number by anonymizing a combination data obtained by linking the individual ID number, and at least one of the anonymization key data and the specimen attribute data, by use of the uni-directional function; and
encrypting the first anonymization number into a second anonymization number.

36. The anonymizing method according to claim 31, wherein said generating an anonymization number comprises:
generating a first anonymization number by encrypting a combination data obtained by linking the individual ID number, and at least one of the anonymization key data and the specimen attribute data; and
generating a second anonymization number obtained by anonymizing the first anonymization number by the uni-directional function.

37. A computer-readable storage medium in which a computer-executable program code is stored to realize an anonymization method in which an individual data and an anonymization number are managed to have a correspondence relation, and a correspondence table of an individual ID number for identifying an individual and the anonymization number is not retained, wherein said anonymization method comprises:
acquiring an individual ID number used to generate an anonymization key;
acquiring an anonymization key data used to generate the anonymization key;
generating an anonymization number anonymized by use of an uni-directional function by linking the individual ID number and the anonymization key data; and
discarding a correspondence table of the individual ID number and the anonymization number after the generation of the anonymization number.

38. The computer-readable storage medium according to claim 37, wherein said anonymization method further comprises:
discarding the anonymization key.

39. The computer-readable storage medium according to claim 37, wherein said generating an anonymization number comprises:
acquiring specimen attribute data from only which the individual cannot be identified; and
generating the anonymization number obtained by anonymizing a combination data which is obtained by linking the individual ID number, the anonymization key data and the specimen attribute data, by use of the uni-directional function.

40. The computer-readable storage medium according to claim 37, said anonymization method further comprises:
verifying an uniqueness of the anonymization number; and
performing a re-input of the anonymization key data corresponding to the anonymization number or reselection of the specimen attribute data from only which an individual cannot be identified, when the verification result indicates that the anonymization number is not unique.

41. The computer-readable storage medium according to claim 37, wherein said generating an anonymization number comprises:
generating a first anonymization number by anonymizing a combination data obtained by linking the individual ID number, and at least one of the anonymization key data and the specimen attribute data, by use of the uni-directional function; and
encrypting the first anonymization number into a second anonymization number.

42. The computer-readable storage medium according to claim 37, wherein said generating an anonymization number comprises:
generating a first anonymization number by encrypting a combination data obtained by linking the individual ID number, and at least one of the anonymization key data and the specimen attribute data; and
generating a second anonymization number obtained by anonymizing the first anonymization number by the uni-directional function.
